(19) United States
(12) Patent Application Publication
(10) Pub. No.: US 2005/0068481 A1
(43) Pub. Date: Mar. 31, 2005

(54) Liquid crystal display device having homeotropic alignment liquid crystal panel

(75) Inventors: Kunpei Kobayashi, Tokyo (JP); Norihiro Arai, Tokyo (JP); Toshiharu Nishino, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: CASIO COMPUTER CO., LTD., Tokyo (JP)

(21) Appl. No.: 10/950,771

(22) Filed: Sep. 27, 2004

(30) Foreign Application Priority Data
Sep. 30, 2003 (JP) 2003-341888
Sep. 30, 2003 (JP) 2003-341889

(51) Int. Cl. G02F 1/1337

(52) U.S. Cl. 349/130

(57) ABSTRACT

A liquid crystal display device includes a homeotropic alignment liquid crystal panel having observation-side and opposite-side substrates which oppose each other, a plurality of electrodes which are arranged on sides of opposing inner surfaces of the substrates and form a plurality of pixels by opposing regions, and a liquid crystal layer which is arranged between the substrates and made of a liquid crystal material with negative dielectric anisotropy in which liquid crystal molecules are aligned substantially vertically with respect to the inner surfaces of the substrates. A pair of polarizing plates are respectively arranged on both sides of the homeotropic alignment liquid crystal panel. A pair of λ/4 retardation plates are respectively arranged between the homeotropic alignment liquid crystal panel and the pair of polarizing plates.

### CROSS-REFERENCE TO RELATED APPLICATIONS

This application is based upon and claims the benefit of priority from prior Japanese Patent Applications No. 2003-341888, filed Sep. 30, 2003; and No. 2003-341889, filed Sep. 30, 2003, the entire contents of both of which are incorporated herein by reference.

### BACKGROUND OF THE INVENTION

1. Field of the Invention

The present invention relates to a liquid crystal display device having a homeotropic alignment liquid crystal display panel in which liquid crystal molecules are aligned almost vertically with respect to a substrate surface in an initial state.

2. Description of the Related Art

As liquid crystal display devices, TN (Twisted Nematic) liquid crystal display devices are widely used. The TN liquid crystal display device includes electrodes, a liquid crystal layer, and a pair of polarizing plates. The electrodes are formed on the opposing inner surfaces of a pair of opposing substrates and form a plurality of pixels by opposing regions. The liquid crystal layer is arranged between the pair of substrates and made of a liquid crystal material having positive dielectric anisotropy. In the liquid crystal layer, the liquid crystal molecules are aligned almost horizontally with respect to the substrate surfaces in a homogeneous alignment and twist-aligned in this state. The pair of polarizing plates are arranged on the outer surfaces of the pair of substrates (Jpn. Pat. Appln. KOKAI Publication No. 11-007048).

The TN liquid crystal display device executes display by controlling the polarized state of incident light by the birefringence effect of the liquid crystal layer. In a liquid crystal display device in a normally white mode, when an OFF voltage which sets the liquid crystal molecules in the initial twist alignment state is applied between the electrodes of pixels, incident light is optically rotated by the liquid crystal layer and passes through the observation-side polarizing plate. Accordingly, bright display is obtained on the pixels. When an ON voltage which raises the liquid crystal molecules almost vertically with respect to the substrate surfaces is applied between the electrodes of the pixels, light that has passed through the liquid crystal layer is absorbed by the observation-side polarizing plate. Accordingly, dark display is obtained on the pixels.

In the TN liquid crystal display device, the liquid crystal molecules are twist-aligned while lying almost horizontally with respect to the substrate surfaces. For this reason, the view angle of display is small.

In addition, in the TN liquid crystal display device, liquid crystal molecules near the substrates are strongly affected by the alignment control force of homogeneous alignment films. Even when the ON voltage is applied, the liquid crystal molecules hardly rise from the initial homogeneous alignment state. That is, even when the ON voltage is applied, the liquid crystal layer has residual retardation. For this reason, in the TN liquid crystal display device in the normally white mode, the darkness of dark display is insufficient, and the contrast of display is low.

### BRIEF SUMMARY OF THE INVENTION

It is an object of the present invention to provide a liquid crystal display device capable of obtaining display at a wide view angle and high contrast.

It is another object of the present invention to provide a liquid crystal display device which can execute both color image display at a wide view angle and high contrast by reflection display using external light as light in the external environment and color image display by transmission display using illumination light from a light source arranged on the opposite side of the observation side, and display color images in both modes sufficiently bright almost without any difference in quality.

In order to achieve the above objects, according to a first aspect of the present invention, there is provide a liquid crystal display device a liquid crystal display device comprising: a homeotropic alignment liquid crystal panel including observation-side and opposite-side substrates which oppose each other, a plurality of electrodes which are arranged on sides of opposing inner surfaces of the substrates and form a plurality of pixels by opposing regions, and a liquid crystal layer which is arranged between the substrates and made of a liquid crystal material with negative dielectric anisotropy in which liquid crystal molecules are aligned substantially vertically with respect to the inner surfaces of the substrates; a pair of polarizing plates which are respectively arranged on both sides of the homeotropic alignment liquid crystal panel; and a pair of λ/4 retardation plates which are respectively arranged between the homeotropic alignment liquid crystal panel and the pair of polarizing plates.

The liquid crystal display device according to the first aspect executes display by controlling the polarized state of incident light by the birefringence effect of the liquid crystal layer of the homeotropic alignment liquid crystal panel and the retardation of the λ/4 retardation plates arranged between both sides of the homeotropic alignment liquid crystal panel and the pair of polarizing plates. In this liquid crystal display device, since the liquid crystal molecules of the liquid crystal layer are aligned almost vertically with respect to the substrate surfaces, the view angle is wide.

In this liquid crystal display device, the liquid crystal layer of the liquid crystal panel is made of a liquid crystal material with negative dielectric anisotropy in which the liquid crystal molecules are aligned substantially vertically with respect to the substrate surfaces. For this reason, when the OFF voltage is applied between the electrodes of the pixels, the liquid crystal molecules are set in the initial homeotropic alignment state. When the ON voltage is applied, almost all the liquid crystal molecules change their alignment state and lie with respect to the substrate surfaces.

According to this liquid crystal display device, when the OFF voltage which sets the liquid crystal molecules in the initial homeotropic alignment state is applied between the electrodes of the pixels, incident light which is changed to circularly polarized light by the λ/4 retardation plate on the opposite side of the observation side passes through the liquid crystal layer almost without being affected by the birefringence effect of the liquid crystal layer. The light is changed by retardation of the λ/4 retardation plate to linearly polarized light which almost matches the absorption axis of the observation-side polarizing plate, and then enters the observation-side polarizing plate. For this reason, the transmittance of the liquid crystal display device is very low. When the ON voltage which sets the liquid crystal molecules in the lying alignment state with respect to the substrate surfaces is applied between the electrodes of the pixels, the polarized state of incident light in the circularly polarized state is controlled by the birefringence effect of the liquid crystal layer and retardation of the λ/4 retardation plate. The light is changed to linearly polarized light which almost matches the transmission axis of the observation-side polarizing plate, and then enters the observation-side polarizing plate. For this reason, the transmittance of the liquid crystal display device is high. Hence, high-contrast display can be obtained.

In this liquid crystal display device, a homeotropic alignment film is preferably formed on each of the inner surfaces of the pair of substrates of the homeotropic alignment liquid crystal display panel on which the plurality of electrodes are formed. A rubbing process is preferably executed for at least one of the inner surfaces of the pair of substrates in a predetermined direction. Accordingly, the lying directions of the liquid crystal molecules at the time of ON voltage application are defined, and a higher contrast can be obtained.

The homeotropic alignment films formed on the inner surfaces of the pair of substrates of the homeotropic alignment liquid crystal panel are preferably subjected to the rubbing process parallel to each other. Accordingly, the lying directions of the liquid crystal molecules at the time of ON voltage application match between the front and back substrates. Since the degree of alignment of the liquid crystal molecules increases, a higher contrast can be obtained.

In this liquid crystal display device, the two λ/4 retardation plates are preferably arranged while setting slow axes perpendicular to each other. One of the two λ/4 retardation plates is preferably arranged while making the slow axis cross an optical axis of one of the pair of polarizing plates substantially at 45°. One of the two λ/4 retardation plates is preferably arranged while setting the slow axis perpendicular to a rubbing direction of the homeotropic alignment film.

The liquid crystal display device, preferably further comprises reflection means, arranged on the inner surface of an opposite-side substrate which opposes an observation-side substrate of the pair of substrates of the homeotropic alignment liquid crystal panel, for dividing each of the plurality of pixels into a reflection display portion which reflects incident light from the observation side to the observation side and a transmission display portion which makes incident light from the opposite-side substrate pass to the observation side. Accordingly, both reflection display using external light as light in the external environment and transmission display using illumination light from a light source arranged on the opposite side of the observation side can be executed.

The homeotropic alignment liquid crystal panel preferably further includes a gap adjusting film to adjust a thickness of the liquid crystal layer.

According to a second aspect of the present invention, there is provide a liquid crystal display device a liquid crystal display device comprising: a homeotropic alignment liquid crystal panel including observation-side and opposite-side substrates which oppose each other, electrodes which are arranged on each of opposing inner surfaces of the pair of substrates and form a plurality of pixels by opposing regions, color filters of three colors of red, green, and blue which are arranged on the inner surface of one of the substrates in correspondence with the plurality of pixels, reflection sections arranged on the opposite-side substrate, each of the reflection sections dividing each of the plurality of pixels into a reflection display portion which reflects incident light from an observation side to the observation side and a transmission display portion which makes incident light from the opposite-side substrate pass to the observation side, and a liquid crystal layer which is sealed between the substrates and made of a liquid crystal material with negative dielectric anisotropy in which liquid crystal molecules are aligned substantially vertically with respect to the inner surfaces of the substrates; observation-side and opposite-side polarizing plates which are respectively arranged on both sides of the homeotropic alignment liquid crystal panel; and a λ/4 retardation plate which is arranged at least between the observation-side substrate and the observation-side polarizing plate.

The liquid crystal display device of the second aspect comprises color filters of three colors, i.e., red, green, and blue and reflection means for dividing each of the plurality of pixels into a reflection display portion which reflects incident light from the observation side to the observation side and a transmission display portion which makes incident light from the opposite-side substrate pass to the observation side. For this reason, both color image display by reflection display using external light as light in the external environment and color image display by transmission display using illumination light from a light source arranged on the opposite side of the observation side can be executed.

In this liquid crystal display device, the reflection means preferably includes a plurality of reflecting films which are arranged in correspondence with the reflection display portions of the plurality of pixels. A three-dimensional pattern such as a wave form pattern, an uneven pattern, a rough pattern of irregular or regular form is preferably formed on the reflecting surfaces of the reflecting films.

In this liquid crystal display device, a transparent opening portion is preferably formed for the reflection display portion of each of the color filters of three colors. A transparent member is preferably formed in the transparent opening portion. The transparent member preferably forms a gap adjusting film which covers the color filters to adjust a thickness of the liquid crystal layer.

According to a third aspect of the present invention, there is provide a liquid crystal display device a liquid crystal display device comprising: a homeotropic alignment liquid crystal panel including observation-side and opposite-side substrates which oppose each other, electrodes which are arranged on each of opposing inner surfaces of the substrates and form a plurality of pixels by opposing regions, color filters of three colors, i.e., red, green, and blue which are arranged on the inner surface of one of the substrates in correspondence with the plurality of pixels, reflection sections arranged on an opposite-side substrate which opposes the observation-side substrate, for dividing each of the plurality of pixels into a reflection display portion which reflects incident light from an observation side to the observation side and a transmission display portion which makes incident light from the opposite-side substrate pass to the observation side, a transparent member which is arranged in correspondence with reflection display portion of each of the pixels of the color filters to adjust a thickness of a liquid crystal layer, and a liquid crystal layer which is arranged between the substrates and made of a liquid crystal material with negative dielectric anisotropy in which liquid crystal molecules are aligned substantially vertically with respect to the inner surfaces of the substrates, and a thickness of the reflection display portions of the plurality of pixels is smaller than that of the transmission display portions; a pair of polarizing plates which are arranged on both sides of the homeotropic alignment liquid crystal panel; and two λ/4 retardation plates which are respectively arranged between the homeotropic alignment liquid crystal panel and the pair of polarizing plates.

The liquid crystal display device of the third aspect comprises a transparent member to make the thickness of the liquid crystal layer at the reflection display portions of the plurality of pixels smaller than that at the transmission display portions. For this reason, the difference between the birefringence effect of the liquid crystal layer for light which reciprocally passes through the liquid crystal layer at the reflection display portions and the birefringence effect of the liquid crystal layer for light which passes through the liquid crystal layer at the transmission display portion only once can be small. A color image by reflection display and that by transmission display can be displayed almost without any difference in quality.

In the liquid crystal display device, the color filter preferably has, at a position corresponding to the reflection display portion, an opening portion to reflect a light component of light incident on the reflection display portion without coloring the light component. The transparent member preferably fills the opening portion of the color filter and is made of a transparent material which is arranged in a region corresponding to the reflection display portion to reduce the thickness of the liquid crystal layer at the reflection display portion.

In this liquid crystal display device, each of the plurality of electrodes of the homeotropic alignment liquid crystal panel preferably includes a transparent electrode formed from a transparent conductive material. The reflection means is preferably formed on a substrate side of the transparent electrode on the opposite-side substrate.

In the liquid crystal display device, the two λ/4 retardation plates are preferably arranged while setting slow axes perpendicular to each other. One of the two λ/4 retardation plates is preferably arranged while making the slow axis cross an optical axis of one of the pair of polarizing plates substantially at 45°.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view of part of a liquid crystal display device according to the first embodiment of the present invention;

FIG. 2 is a view showing the rubbing directions of the pair of substrates, the directions of the transmission axes of observation- and opposite-side polarizing plates, and the directions of the slow axes of the observation- and opposite-side λ/4 retardation plates in the liquid crystal display device;

FIGS. 3A and 3B are schematic views showing the alignment states of liquid crystal molecules according to the first embodiment at the times of OFF voltage application and ON voltage application, respectively;

FIGS. 4A and 4B are schematic views showing a change in the polarized state of transmitted light when the liquid crystal display device executes transmission display, in which FIG. 4A shows the state at the time of OFF voltage application, and FIG. 4B shows the state at the time of ON voltage application;

FIG. 5 is a sectional view of part of a liquid crystal display device according to the second embodiment of the present invention;

FIG. 6 is a sectional view of part of a liquid crystal display device according to the third embodiment of the present invention;

FIGS. 7A and 7B are schematic views showing an example of the alignment states of liquid crystal molecules which can be applied to the liquid crystal layer of the liquid crystal display device used in the present invention, in which FIG. 7A shows the alignment state at the time of OFF voltage application, and FIG. 7B shows the alignment state at the time of ON voltage application;

FIGS. 8A and 8B are schematic views showing another example of the alignment states of liquid crystal molecules which can be applied to the liquid crystal layer of the liquid crystal display device used in the present invention, in which FIG. 8A shows the alignment state at the time of OFF voltage application, and FIG. 8B shows the alignment state at the time of ON voltage application;

FIGS. 9A and 9B are schematic views showing still another example of the alignment states of liquid crystal molecules which can be applied to the liquid crystal layer of the liquid crystal display device used in the present invention, in which FIG. 9A shows the alignment state at the time of OFF voltage application, and FIG. 9B shows the alignment state at the time of ON voltage application;

FIG. 10 is a sectional view of part of a liquid crystal display device according to the fourth embodiment of the present invention;

FIG. 11 is a view showing the rubbing directions of the pair of substrates, the directions of the transmission axes of observation- and opposite-side polarizing plates, and the directions of the slow axes of the observation- and opposite-side λ/4 retardation plates in the liquid crystal display device;

FIGS. 12A and 12B are schematic views showing the alignment states of liquid crystal molecules according to the fourth embodiment at the times of OFF voltage application and ON voltage application, respectively;

FIGS. 13A and 13B are schematic views showing a change in the polarized state of reflected light when the liquid crystal display device according to the fourth embodiment executes reflection display, in which FIG. 13A shows the state at the time of OFF voltage application, and FIG. 13B shows the state at the time of ON voltage application;

FIGS. 14A and 14B are schematic views showing a change in the polarized state of transmitted light when the liquid crystal display device according to the fourth embodiment executes transmission display, in which FIG. 14A shows the state at the time of OFF voltage application, and FIG. 14B shows the state at the time of ON voltage application;

FIGS. 15A and 15B are schematic views showing still another example of the alignment states of liquid crystal molecules which can be applied to the liquid crystal layer of the liquid crystal display device used in the present invention, in which FIG. 15A shows the alignment state at the time of OFF voltage application, and FIG. 15B shows the alignment state at the time of ON voltage application;

FIGS. 16A and 16B are schematic views showing still another example of the alignment states of liquid crystal molecules which can be applied to the liquid crystal layer of the liquid crystal display device used in the present invention, in which FIG. 16A shows the alignment state at the time of OFF voltage application, and FIG. 16B shows the alignment state at the time of ON voltage application; and

FIG. 17 is a sectional view of part of a liquid crystal display device according to the fifth embodiment of the present invention.

### DETAILED DESCRIPTION OF THE INVENTION

Liquid crystal display devices will be described below as embodiments of the present invention with reference to the accompanying drawings.

[First Embodiment]

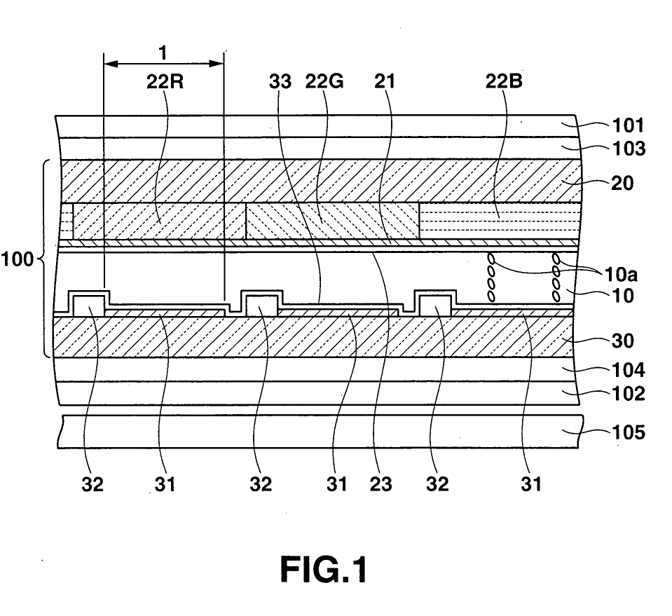

FIGS. 1 to 4 show the first embodiment of the present invention. FIG. 1 is a sectional view of part of a liquid crystal display device.

As shown in FIG. 1, the liquid crystal display apparatus or device of this embodiment comprises a homeotropic alignment liquid crystal panel or unit 100, a pair of observation- and opposite-side polarizing plates 101 and 102, and two λ/4 retardation plates 103 and 104. The polarizing plates 101 and 102 are arranged on both sides of the liquid crystal panel 100. The λ/4 retardation plates 103 and 104 are arranged between the liquid crystal panelpanel 100 and the pair of polarizing plates 101 and 102.

The homeotropic alignment liquid crystal panelpanel 100 includes a pair of transparent substrates 20 and 30, transparent electrodes 21 and 31, color filters 22R, 22G, and 22B of three colors, i.e., red, green, and blue, and a liquid crystal layer 10. The first and second transparent substrates 20 and 30 are arranged on the observation side (upper side in FIG. 1) and on the opposite side (lower side in FIG. 1) and oppose each other. The transparent electrodes 21 and 31 are respectively formed on the opposing inner surfaces of the pair of substrates 20 and 30 and form a plurality of pixels 1 by opposing regions. The plurality of sets of the color filters 22R, 22G, and 22B are arranged on the inner surface of one of the pair of substrates 20 and 30 and, for example, the observation-side substrate 20 in correspondence with the plurality of pixels 1. The liquid crystal layer 10 is made of a liquid crystal material having negative dielectric anisotropy. The liquid crystal layer 10 is sealed between the substrates 20 and 30 while aligning liquid crystal molecules 10a almost vertically with respect to the surfaces of the substrates 20 and 30.

The liquid crystal panelpanel 100 is an active matrix liquid crystal panel. In this panel, the counter electrode 21 (one of the transparent electrodes) having a single film shape is formed on the inner surface of the observation-side substrate 20. The plurality of pixel electrodes 31 (the other of the transparent electrodes) are arrayed in a matrix along the row and column directions on the inner surface of the opposite-side substrate 30. The plurality of pixel electrodes 31 are electrically connected to a plurality of TFTs 32 formed on the inner surface of the second substrate 30, respectively.

The TFTs 32 are simplified in FIG. 1. Each TFT 32 actually includes a gate electrode formed on the substrate surface of the opposite-side substrate 30, a transparent gate insulating film formed almost on the entire surface of the substrate 30 and covers the gate electrode, an i-type semiconductor film formed on the gate insulating film to oppose the gate electrode, and source and drain electrodes formed on n-type semiconductor films on both end portions of the i-type semiconductor film.

Although not illustrated in FIG. 1, a plurality of gate wiring lines which supply a gate signal to the TFTs 32, and a plurality of data wiring lines which supply a data signal to the TFTs 32 are arranged on the inner surface of the opposite-side substrate 30. The gate wiring lines are formed on the substrate surface of the opposite-side substrate 30 integrally with the gate electrodes of the TFTs 32 and covered with the gate insulating film. The data wiring lines are formed on the gate insulating film and electrically connected to the drain electrodes of the TFTs 32.

The plurality of pixel electrodes 31 are formed on the gate insulating film and electrically connected to the respective source electrodes of the TFTs 32.

The red, green, and blue color filters 22R, 22G, and 22B arranged on the inner surface of the observation-side substrate 20 are formed on the substrate surface of the first substrate 20. The counter electrode 21 is formed on the color filters 22R, 22G, and 22B.

Homeotropic alignment films 23 and 33 are formed on the inner surfaces of the first and second substrate 20 and 30, and cover the electrodes 21 and 31, respectively. The inner sides of the substrates 20 and 30, i.e., the film surfaces of the homeotropic alignment films 23 and 33 are subjected to a rubbing process in directions parallel to each other.

The both substrates 20 and 30 are bonded via a frame-shaped sealing member or from (not shown) which surrounds the display area where the plurality of pixels 1 are arrayed in a matrix. The region surrounded by the sealing member between both substrates 20 and 30 is filled with a liquid crystal material having negative dielectric anisotropy and, for example, a nematic liquid crystal having negative dielectric anisotropy to form the liquid crystal layer 10.

The liquid crystal molecules 10a of the liquid crystal layer 10 are aligned almost vertically with respect to the inner surfaces of the substrates 20 and 30. When an ON voltage is applied between the electrodes 21 and 31 of the plurality of pixels 1, the liquid crystal molecules 10a are set in a lying alignment state while aligning their long axes along the rubbing directions of the alignment films 23 and 33.

In this embodiment, the gap between the pair of substrates 20 and 30 (more exactly, the gap between the homeotropic alignment films 23 and 33) and the liquid crystal material are appropriately selected so that a product Δnd of a liquid crystal layer thickness d and a refractive index anisotropy Δn of the liquid crystal in the liquid crystal layer 10 at the time of ON voltage application, i.e., when the liquid crystal molecules 10a are set in the lying alignment state while aligning their long axes along the rubbing directions is set to Δnd=270±40 nm.

The pair of observation- and opposite-side polarizing plates 101 and 102 are absorption polarizing plates which have a transmission axis and absorption axis in directions perpendicular to each other. The observation-side polarizing plate 101 is arranged to oppose the outer surface of the observation-side substrate 20 of the liquid crystal panelpanel 100. The opposite-side polarizing plate 102 is arranged to oppose the outer surface of the opposite-side substrate 30 of the liquid crystal panel 100.

The two λ/4 retardation plates 103 and 104 are retardation plates which give a retardation of ¼ wavelength (140±40 nm) to transmitted light. One λ/4 retardation plate (to be referred to as an observation-side λ/4 retardation plate hereinafter) 103 is arranged between the observation-side polarizing plate 101 and the corresponding substrate 20 of the liquid crystal panel 100. The other λ/4 retardation plate (to be referred to as an opposite-side λ/4 retardation plate hereinafter) 104 is arranged between the opposite-side polarizing plate 102 and the corresponding substrate 30 of the liquid crystal panel 100.

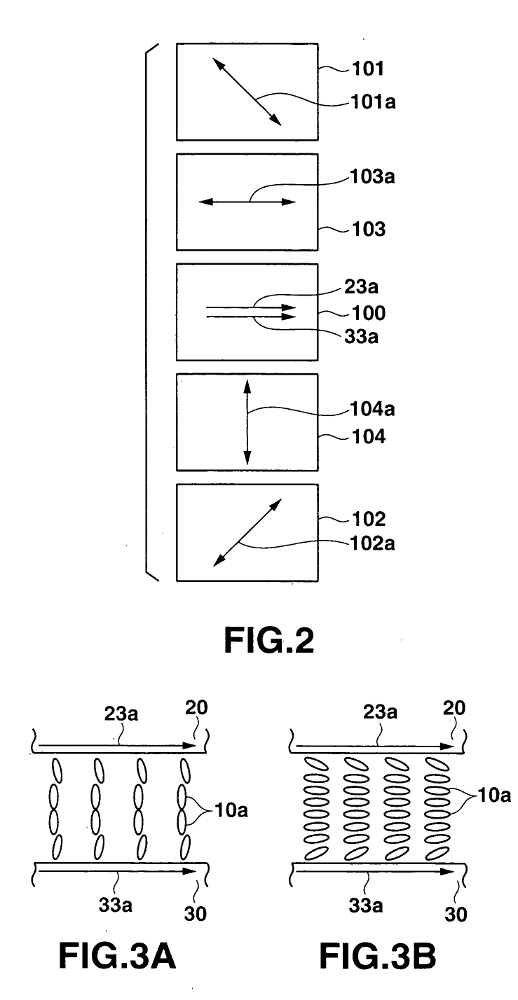

FIG. 2 shows rubbing directions 23a and 33a of the inner surfaces of the pair of substrates 20 and 30 (the film surfaces of the homeotropic alignment films 23 and 33), the directions of transmission axes 101a and 102a of the observation- and opposite-side polarizing plates 101 and 102, and the directions of slow axes 103a and 104a of the observation- and opposite-side λ/4 retardation plates 103 and 104 in the liquid crystal panel 100.

As shown in FIG. 2, the inner surfaces of the pair of substrates 20 and 30 of the liquid crystal panel 100 are subjected to a rubbing process parallel to each other in the same direction. The transmission axis 101a of the observation-side polarizing plate 101 obliquely crosses the rubbing directions 23a and 33a of the inner surfaces of the pair of substrates 20 and 30 almost at an angle of 45°. The transmission axis 102a of the opposite-side polarizing plate 102 is almost perpendicular to the transmission axis 101a of the observation-side polarizing plate 101.

The slow axis 103a of the observation-side λ/4 retardation plate 103 is almost parallel or almost perpendicular to the rubbing directions 23a and 33a of the inner surfaces of the pair of substrates 20 and 30 so as to obliquely cross the transmission axis 101a of the observation-side polarizing plate 101 almost at an angle of 45°. The slow axis 104a of the opposite-side λ/4 retardation plate 104 is almost perpendicular to the slow axis 103a of the observation-side λ/4 retardation plate 103 (almost perpendicular or almost parallel to the rubbing directions 23a and 33a of the inner surfaces of the pair of substrates 20 and 30) so as to obliquely cross the transmission axis 102a of the opposite-side polarizing plate 102 almost at an angle of 45°.

This liquid crystal display device executes display by controlling the polarized state of incident light by the birefringence effect of the liquid crystal layer 10 arranged between the substrates 20 and 30 of the liquid crystal panel 100 and the retardations of the two λ/4 retardation plates respectively arranged between the first and second substrates 20 and 30 and the observation- and opposite-side polarizing plates 101 and 102. This liquid crystal display device has a wide view angle because the liquid crystal molecules 10a of the liquid crystal layer 10 are aligned almost vertically with respect to the inner surfaces of the substrates 20 and 30.

In this liquid crystal display device, the liquid crystal layer 10 is made of a liquid crystal material having negative dielectric anisotropy in which the liquid crystal molecules 10a are aligned almost vertically with respect to the inner surfaces of the substrates 20 and 30. The alignment control force of the homeotropic alignment films 23 and 33 formed on the inner surfaces of the substrates 20 and 30 is smaller than that of a homogeneous alignment film. For this reason, when an OFF voltage is applied between the electrodes 21 and 31 of the pixels 1, the liquid crystal molecules 10a are almost set in a homeotropic alignment state. When an ON voltage is applied, almost all the liquid crystal molecules 10a between the pair of substrates 20 and 30 change their alignment state and lie with respect to the substrate surfaces.

FIGS. 3A and 3B are schematic views respectively showing the alignment states of the liquid crystal molecules 10a at the times of OFF voltage application and ON voltage application. In this embodiment, the inner surfaces of the substrates 20 and 30 of the liquid crystal panel 100 are subjected to a rubbing process parallel to each other in the same direction. Hence, when the ON voltage is applied, the liquid crystal molecules 10a in the homeotropic alignment state at the time of OFF voltage application shown in FIG. 3A change to a splay alignment state in which the liquid crystal molecules lie while aligning their long axes along the rubbing directions 23a and 33a of the substrates 20 and 30, as shown in FIG. 3B.

According to this liquid crystal display device, when the OFF voltage which sets the liquid crystal molecules 10a in the initial homeotropic alignment state is applied between the electrodes 21 and 31 of the pixels 1, incident light which is circularly polarized by the λ/4 retardation plate on the opposite side of the observation side passes through the liquid crystal layer 10 almost without being affected by the birefringence effect of the liquid crystal layer 10. The light is changed by retardation of the observation-side λ/4 retardation plate 103 to linearly polarized light which almost matches the absorption axis of the observation-side polarizing plate 101, and then enters the observation-side polarizing plate 101. Thus, the transmittance of the liquid crystal display device is very low. When the ON voltage which sets the liquid crystal molecules 10a in the lying alignment state with respect to the inner surfaces of the substrates 20 and 30 is applied between the electrodes 21 and 31 of the pixels 1, the polarized state of incident light in the circularly polarized state is controlled by the birefringence effect of the liquid crystal layer 10 and retardation of the λ/4 retardation plate 103. The light is converted into linearly polarized light which almost matches the transmission axis 101a of the observation-side polarizing plate 101, and then enters the observation-side polarizing plate 101. For this reason, the transmittance of the liquid crystal display device is high. Hence, high-contrast display can be obtained.

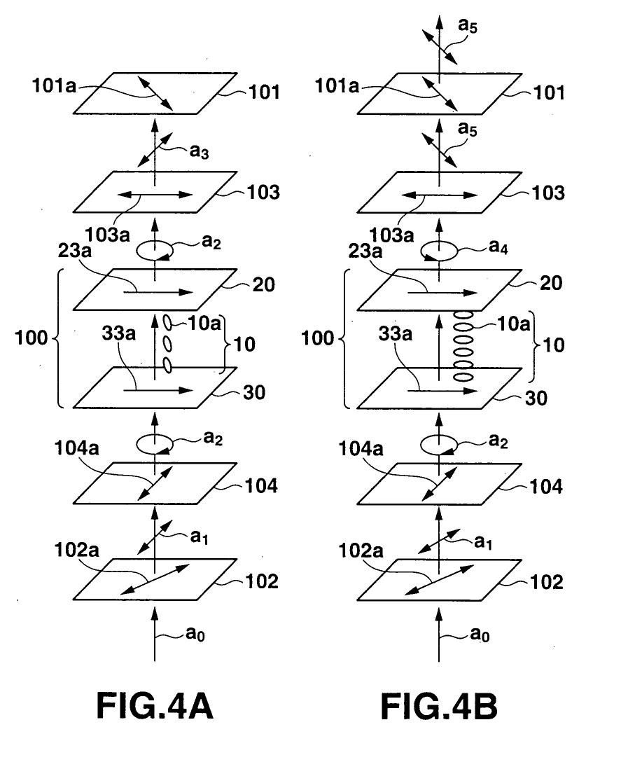

FIGS. 4A and 4B are schematic views showing a change in the polarized state of transmitted light when the liquid crystal display device executes transmission display. In referring to FIGS. 4A and 4B, a display operation of one pixel 1 of the liquid crystal panel 100 is illustrated.

This liquid crystal display device executes transmission display using illumination light from a surface light source 105 (FIG. 1) arranged on the opposite side of the observation side. FIG. 4A shows display when the OFF voltage which sets the liquid crystal molecules 10a in the initial homeotropic alignment state is applied between the electrodes 21 and 31 of the pixel 1. FIG. 4B shows display when the ON voltage which sets the liquid crystal molecules 10a in the lying alignment state is applied between the electrodes 21 and 31 of the pixel 1.

The display operation of the liquid crystal display device will be described. As indicated by arrows in FIGS. 4A and 4B, illumination light a₀ from the surface light source 105 is changed by the opposite-side polarizing plate 102 to linearly polarized light a₁ parallel to the transmission axis 102a. The linearly polarized light a₁ is further changed by the opposite-side λ/4 retardation plate 104 to circularly polarized light a₂ clockwise or counterclockwise when viewed from the traveling direction of the light and enters the liquid crystal layer 10 of the liquid crystal panel 100.

At the time of OFF voltage application, the liquid crystal molecules 10a of the liquid crystal layer 10 are aligned almost vertically. For this reason, light which is changed by the opposite-side λ/4 retardation plate 104 to the circularly polarized light a₂ and enters the liquid crystal panel 100 passes through the liquid crystal layer 10 as the circularly polarized light a₂ almost without being affected by the birefringence effect of the liquid crystal layer 10 and emerges to the observation side of the liquid crystal panel 100, as shown in FIG. 4A.

The circularly polarized light a₂ which emerges to the observation side of the liquid crystal panel 100 is changed by retardation of the λ/4 retardation plate 103 to linearly polarized light which matches an absorption axis almost perpendicular to the transmission axis 101a of the observation-side polarizing plate 101, i.e., linearly polarized light a₃ which is almost the same as the linearly polarized light a₁ that has passed through the opposite-side polarizing plate 102 and entered. The linearly polarized light a₃ enters the observation-side polarizing plate 101 and is absorbed by it. Hence, the pixel 1 to which the OFF voltage is applied exhibits dark display in black.

At the time of ON voltage application, the liquid crystal molecules 10a of the liquid crystal layer 10 are set in the lying alignment state while aligning their long axes along the rubbing directions 23a and 33a of the surfaces of the substrates 20 and 30, as described above. For this reason, the light which is changed by the opposite-side λ/4 retardation plate 104 to the circularly polarized light a₂ and enters the liquid crystal panel 100 changes its polarized state by the birefringence effect of the liquid crystal layer 10 and emerges to the observation side of the liquid crystal panel 100.

The birefringence effect of the liquid crystal layer 10 at the time of ON voltage application is almost the same as that of a λ/2 retardation plate because the value Δnd when the liquid crystal molecules 10a are set in the lying alignment state is 270±40 nm, as described above. Hence, the light which is changed to the circularly polarized light a₂ by the opposite-side λ/4 retardation plate 104 and enters the observation-side polarizing plate 101 is converted by the liquid crystal layer 10 to circularly polarized light a₄ which rotates in the reverse direction, and then emerges to the observation side of the liquid crystal panel 100.

The circularly polarized light a₄ which emerges to the observation side of the liquid crystal panel 100 is converted by the birefringence effect of the liquid crystal layer 10 and retardation of the λ/4 retardation plate 103 to linearly polarized light which almost matches the transmission axis 101a of the observation-side polarizing plate 101, i.e., linearly polarized light as which is almost perpendicular to the linearly polarized light a₁ that has passed through the opposite-side polarizing plate 102 and entered. The linearly polarized light as passes through the observation-side polarizing plate 101 and emerges to the observation side. The pixel 1 to which the ON voltage is applied exhibits bright display in one of red, green, and blue colored by the color filters 22R, 22G, and 22B.

That is, the liquid crystal display device executes display in a normally black mode. When the OFF voltage is applied to set the liquid crystal molecules 10a in the initial homeotropic alignment state, darkest display in black is obtained. When the ON voltage is applied to set the liquid crystal molecules 10a in the lying alignment state, brightest display (display in colored red, green, or blue) is obtained.

According to this liquid crystal display device, display at a wide view angle and high contrast can be obtained.

In this liquid crystal display device, the homeotropic alignment films 23 and 33 are formed on the inner surfaces of the respective substrates 20 and 30 of the liquid crystal panel 100. In addition, the inner surfaces of the substrates (the film surfaces of the homeotropic alignment films 23 and 33) are subjected to a rubbing process in directions parallel to each other. For these reasons, the lying directions of the liquid crystal molecules 10a at the time of ON voltage application can be aligned along the rubbing directions 23a and 33a. Hence, a higher contrast can be obtained.

[Second Embodiment]

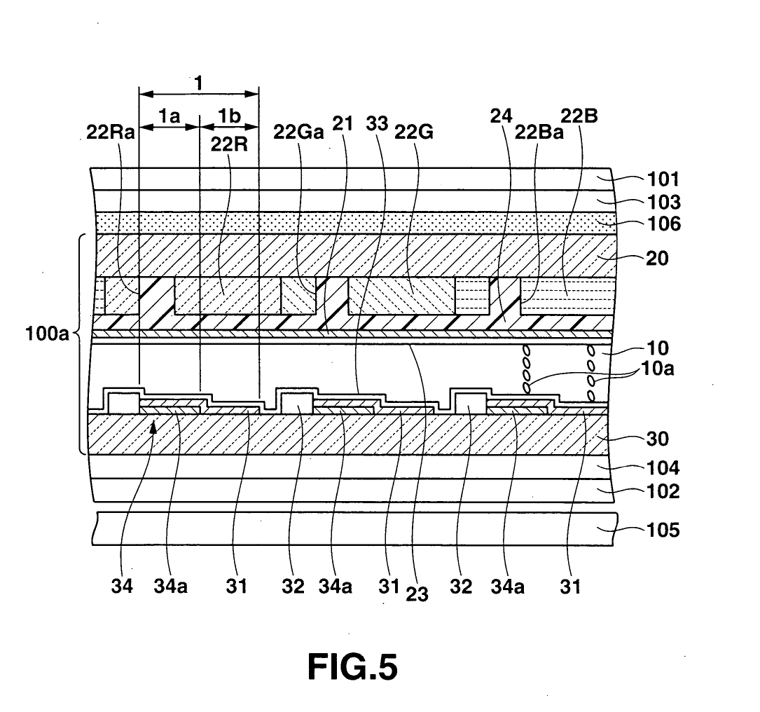

FIG. 5 is a sectional view of part of a liquid crystal display device according to the second embodiment of the present invention. The liquid crystal display apparatus comprises a homeotropic alignment liquid crystal panel 100a which has a reflection means 34 provided on the inner surface of a second substrate 30 on the opposite side of the observation side. The reflection means 34 divides each of a plurality of pixels 1 into a reflection display portion 1a and a transmission display portion 1b. The reflection display portion 1a reflects backward incident light from the observation side to the observation side. The transmission display portion 1b makes incident light from the opposite side pass to the observation side.

The reflection means 34 includes a plurality of regular reflecting films 34a which are arranged on the above-described gate insulating film (which is omitted in FIG. 4) in correspondence with the reflection display portions 1a of the plurality of pixels 1. A plurality of pixel electrodes 31 are formed on the gate insulating film while partially overlapping the regular reflecting films 34a.

In this embodiment, the regular reflecting film 34a is formed in correspondence with an almost half region of each pixel 1. The almost half region of each of the pixels 1 is used as the reflection display portion 1a. The remaining almost half region is used as the transmission display portion 1b.

Color filters 22R, 22G, and 22B of three colors, i.e., red, green, and blue are arranged on the inner surface of an observation-side substrate 20 of the liquid crystal panel 100a in correspondence with each of the pixels 1. The color filters 22R, 22G, and 22B have openings 22Ra, 22Ga, and 22Ba partially at portions corresponding to the reflection display portions 1a of the pixels 1.

A planarization film 24 formed from a transparent insulating film is provided on the color filters 22R, 22G, and 22B while filling the openings 22Ra, 22Ga, and 22Ba. A counter electrode 21 is formed on the planarization film 24.

Homeotropic alignment films 23 and 33 are formed on the inner surfaces of the pair of substrates 20 and 30 of the liquid crystal panel 100a. The inner surfaces of the substrates 20 and 30 (the film surfaces of the homeotropic alignment films 23 and 33) are subjected to a rubbing process parallel to each other in the same direction.

A liquid crystal layer 10 made of a liquid crystal material having negative dielectric anisotropy is arranged between the pair of substrates 20 and 30. In the liquid crystal layer 10, liquid crystal molecules 10a are aligned almost vertically with respect to the surfaces of the substrates 20 and 30. A value Δnd of the liquid crystal layer 10 at the time of ON voltage application, i.e., when the liquid crystal molecules 10a are set in a lying alignment state while aligning their long axes along the rubbing directions is set to Δnd=195±40 nm.

In the liquid crystal panel of this embodiment, a diffusion layer 106 is arranged between the liquid crystal panel 100a and an observation-side λ/4 retardation plate 103. The diffusion layer 106 is a front diffusion layer which diffuses incident light from one surface and outputs it from the opposite surface. The diffusion layer 106 is made of an adhesive or resin film in which light diffusion particles are mixed.

The liquid crystal display device of this embodiment is different from the liquid crystal panel 100 of the above-described first embodiment in that the diffusion layer 106 is inserted between the liquid crystal panel 100a and the observation-side λ/4 retardation plate 103. However, the arrangement states of polarizing plates 101 and 102 and the λ/4 retardation plates 103 and 104 are the same as in the first embodiment. The same reference numerals denote the same members, and a repetitive description thereof will be omitted.

This liquid crystal display device has, on the inner surface of the substrate 30 on the opposite side of the observation side of the liquid crystal panel 100a, the reflection means 34 for dividing each of the plurality of pixels 1 into the reflection display portion 1a which reflects incident light from the observation side to the observation side and the transmission display portion 1b which makes incident light from the opposite side pass to the observation side. For this reason, the liquid crystal display device can execute both color image display by reflection display using external light as light in the external environment and color image display by transmission display using illumination light from the surface light source 105 arranged on the opposite side of the observation side.

More specifically, this liquid crystal display device executes reflection display and transmission display. In reflection display, of light which enters from the observation side, passes through the observation-side polarizing plate 101 and observation-side λ/4 retardation plate 103, and enters the liquid crystal panel 100a, a light component which enters the reflection display portions 1a of the plurality of pixels 1 of the liquid crystal panel 100a and passes through the liquid crystal layer 10 is reflected by the regular reflecting films 34a of the reflection means 34. The reflected light passes again through the liquid crystal layer 10 of the liquid crystal panel 100a, the observation-side λ/4 retardation plate 103, and the observation-side polarizing plate 101 and emerges to the observation side. In transmission display, of light which enters from the opposite side of the observation side, passes through the opposite-side polarizing plate 102 and opposite-side λ/4 retardation plate 104, and enters the liquid crystal panel 100a, a light component which enters the transmission display portions 1b of the plurality of pixels 1 of the liquid crystal panel 100a passes through the liquid crystal layer 10, observation-side λ/4 retardation plate 103, and observation-side polarizing plate 101 and emerges to the observation side.

In this liquid crystal display device, the liquid crystal molecules 10a of the liquid crystal layer 10 of the liquid crystal panel 100a are aligned almost vertically with respect to the inner surfaces of the substrates 20 and 30. For this reason, a wide view angle can be obtained in both reflection display and transmission display.

In reflection display, the liquid crystal display device executes display by controlling the polarized state of incident light by the birefringence effect of the liquid crystal layer 10 of the liquid crystal panel 100a and retardation of the observation-side λ/4 retardation plate 103. In transmission display, the liquid crystal display device executes display by controlling the polarized state of incident light by retardation of the opposite-side λ/4 retardation plate 104, the birefringence effect of the liquid crystal layer 10 of the liquid crystal panel 100a, and the retardation of the observation-side λ/4 retardation plate 103, as in the first embodiment. Hence, high-contrast display can be obtained.

In this liquid crystal display device, as described above, the value Δnd of the liquid crystal layer 10 when the liquid crystal molecules 10a of the liquid crystal panel 100a are set in the lying alignment state while aligning their long axes along the rubbing directions is set to 195±40 nm. For this reason, the liquid crystal display device can execute display in a normally black mode. That is, when the OFF voltage is applied to set the liquid crystal molecules 10a in the initial homeotropic alignment state, darkest display in black is obtained. When the ON voltage is applied to set the liquid crystal molecules 10a in the lying alignment state, brightest display (display in red, green, or blue colored by the color filters 22R, 22G, and 22B) is obtained.

The liquid crystal display device has, on the inner surface of the substrate 30 on the opposite side of the observation side of the liquid crystal panel 100a, the reflection means 34 for dividing each of the plurality of pixels 1 into the reflection display portion 1a and the transmission display portion 1b. In reflection display using external light, only absorption by the observation-side polarizing plate 101 is done. Hence, even a color image by reflection display can sufficiently be bright.

In this liquid crystal display device, the red, green, and blue color filters 22R, 22G, and 22B respectively have the openings 22Ra, 22Ga, and 22Ba partially corresponding to the reflection display portions 1a of the pixels 1. In reflection display, colored light components in red, green, and blue colored by the color filters 22R, 22G, and 22B and noncolored light components that have passed through the openings 22Ra, 22Ga, and 22Ba of the color filters 22R, 22G, and 22B emerge from the reflection display portions 1a of the plurality of pixels 1 so that light containing mixed components is observed. Hence, a color image by bright reflection display can be displayed.

As described above, according to this liquid crystal display device, display at a wide view angle and high contrast can be obtained. In addition, both color image display by reflection display using external light and color image display by transmission display using illumination light from the surface light source 105 arranged on the opposite side of the observation side can be executed. Color images in both modes can sufficiently be bright.

The surface light source 105 can also be used as an auxiliary light source in reflection display using external light. Even in this case, since both reflection display and transmission display are in the normally black mode, high-contrast display can be obtained.

In this liquid crystal display device, the diffusion layer 106 is arranged between the liquid crystal panel 100a and the observation-side λ/4 retardation plate 103. Since light reflected by the regular reflecting films 34a in reflection display is diffused by the diffusion layer 106 and emerges, brighter reflection display can be executed. In addition, the view angle can be made wide in both reflection display and transmission display.

In the liquid crystal display device of the above-described embodiment, only one of the λ/4 retardation plates 103 and 104 may be arranged between the liquid crystal panel 100a and one of the pair of polarizing plates 101 and 102.

[Third Embodiment]

In the liquid crystal display device of the second embodiment, a three-dimensional pattern may be formed on the reflecting surface of the reflecting film which forms the reflection means 34, and the diffusion layer 106 may be omitted, as will be described below.

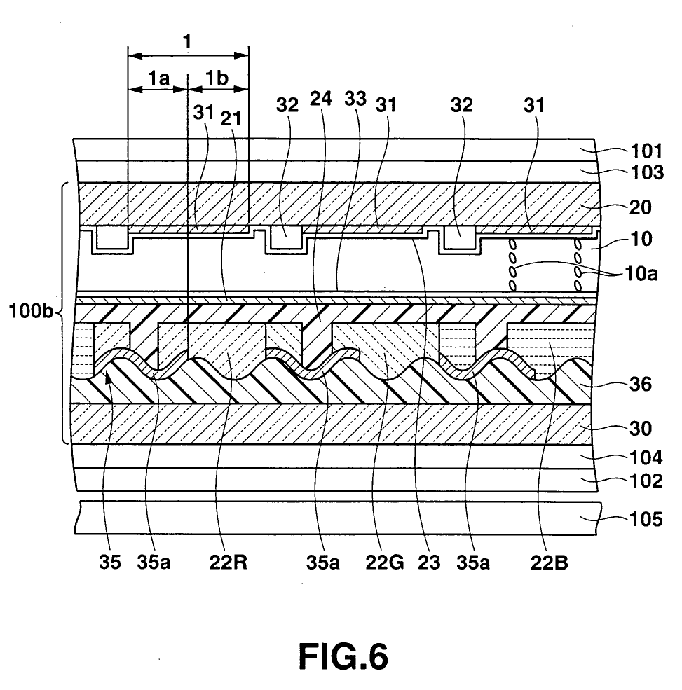

FIG. 6 is a sectional view of part of a liquid crystal display device according to the third embodiment of the present invention. The liquid crystal display device comprises a homeotropic alignment liquid crystal panelpanel 100b in which a reflection means 35 is formed by a plurality of reflecting films 35a having a three-dimensional pattern such as an regular waveform pattern on their reflecting surfaces.

In this embodiment, the liquid crystal panel 100b is an active matrix liquid crystal panel. The liquid crystal panel 100b has, on the inner surface of an observation-side substrate 20, a plurality of pixel electrodes 31, TFTs 32, gate wiring lines (not shown), and data wiring lines (not shown). The liquid crystal panel 100b has, on the inner surface of an opposite-side substrate 30, the reflection means 35, color filters 22R, 22G, and 22B of three colors, i.e., red, green, and blue, a planarization film 24, and a counter electrode 21. The reflecting films 35a which form the reflection means 35 adhere to a transparent three-dimensional surface film 36 arranged on the substrate surface of the opposite-side substrate 30. The entire surface of the three-dimensional surface film 36 is formed into a three-dimensional pattern.

In the liquid crystal display device of this embodiment, the structure of the liquid crystal panel 100b is different from the liquid crystal panel 100a of the above-described second embodiment. In addition, the diffusion layer 106 of the second embodiment is omitted. However, a liquid crystal layer 10 of the liquid crystal panel 100b, a value Δnd1 of reflection display portions 1a of a plurality of pixels 1, and a value Δnd2 of transmission display portions 1b are the same as in the second embodiment. The arrangement states of polarizing plates 101 and 102 and λ/4 retardation plates 103 and 104 are also the same as in the first and second embodiments, and a repetitive description thereof will be omitted.

In this liquid crystal display device, the reflection means 35 for dividing each of the plurality of pixels 1 of the liquid crystal panel 100b into the reflection display portion 1a and transmission display portion 1b is formed by the plurality of reflecting films 35a. The reflecting films 35a have three-dimensional patterns on their reflecting surfaces and are arranged in correspondence with the reflection display portions 1a for the plurality of pixels 1. For this reason, reflection display using external light can be brighter, and the view angle can be wider.

In this embodiment, the three-dimensional surface film 36 having a three-dimensional pattern on the entire surface is arranged on the substrate surface of the opposite-side substrate 30 of the liquid crystal panel 100b. The reflecting films 35a are formed on the three-dimensional surface film 36. For this reason, even in transmission display using illumination light from a surface light source 105, diffused light can emerge from the three-dimensional surface film 36 so that the view angle can be wider.

In this embodiment, a three-dimensional pattern is formed on the reflecting surfaces of the reflecting films 35a by making them adhere to the three-dimensional surface film 36.

The three-dimensional pattern may be formed on the reflecting surfaces of the reflecting films 35a by another means. In addition, undiffused light may emerge in transmission display.

In the above-described embodiments, the inner surfaces of the pair of substrates 20 and 30 (the film surfaces of the homeotropic alignment films 23 and 33) of each of the liquid crystal panels 100, 100a, and 100b are subjected to a rubbing process parallel to each other in the same direction. However, the rubbing process of the inner surfaces of the substrates 20 and 30 may be executed in different directions. Alternatively, the rubbing process may be executed for the inner surface of only one of the pair of substrates 20 and 30.

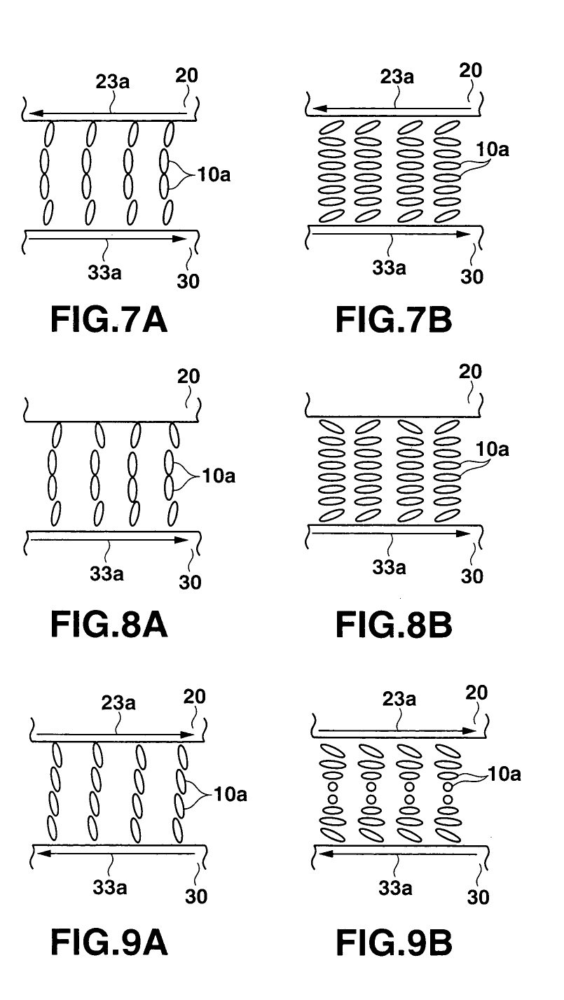

FIGS. 7A and 7B are schematic views respectively showing the alignment states of the liquid crystal molecules 10a at the times of OFF voltage application and ON voltage application. As shown in FIGS. 7A and 7B, the inner surfaces of the pair of substrates 20 and 30 of the liquid crystal panel may be subjected to a rubbing process parallel to each other in reverse directions. In this case, when the ON voltage is applied, the liquid crystal molecules 10a in the homeotropic alignment state at the time of OFF voltage application shown in FIG. 7A are set in an untwisted homogeneous alignment state in which the liquid crystal molecules lie while aligning their long axes along the rubbing directions 23a and 33a of the substrates 20 and 30, as shown in FIG. 7B. Hence, the lying direction of the liquid crystal molecules 10a when the ON voltage is applied can be defined along the rubbing direction, and a high contrast can be obtained.

As shown in FIGS. 8A and 8B, a rubbing process is executed for only the inner surface of one of the pair of substrates 20 and 30 and, for example, the inner surface of the opposite-side substrate 30 of the liquid crystal panel.

In this case, when the ON voltage is applied, the liquid crystal molecules 10a in the homeotropic alignment state at the time of OFF voltage application shown in FIG. 8A almost horizontally lie while aligning their long axes along the rubbing direction 33a of the substrate 30, as shown in FIG. 8B. Hence, a high contrast can be obtained, and the view angle of display can be wider.

As shown in FIGS. 9A and 9B, the inner surfaces of the substrates 20 and 30 of the liquid crystal panel are subjected to a rubbing process in oblique directions that cross each other.

In this case, when the ON voltage is applied, the liquid crystal molecules 10a in the homeotropic alignment state at the time of OFF voltage application shown in FIG. 9A lie while being twisted at a twist angle corresponding to the cross angle of the rubbing directions 23a and 33a of the pair of substrates 20 and 30, as shown in FIG. 9B. Hence, a high contrast can be obtained.

When the liquid crystal molecules 10a are to be set in the twisted lying alignment state by applying the ON voltage, the rubbing directions 23a and 33a of the pair of substrates 20 and 30 are preferably set such that the liquid crystal molecules 10a lie while being twisted at a twist angle of 650±10° upon application of the ON voltage. The transmission axes 101a and 102a of the pair of polarizing plates 101 and 102 are preferably set almost perpendicular to each other. In addition, the transmission axis of one of the polarizing plates is preferably set almost perpendicular or parallel to the rubbing direction of the substrate on the arrangement side of that polarizing plate. The slow axes 103a and 104a of the pair of λ/4 retardation plates 103 and 104 are preferably set almost perpendicular to each other. In addition, the slow axis of one of the λ/4 retardation plates is preferably made to cross the rubbing direction of the substrate on the arrangement side of that λ/4 retardation plate at an angle of 45°. With this settings, a high contrast can be obtained.

[Fourth Embodiment]

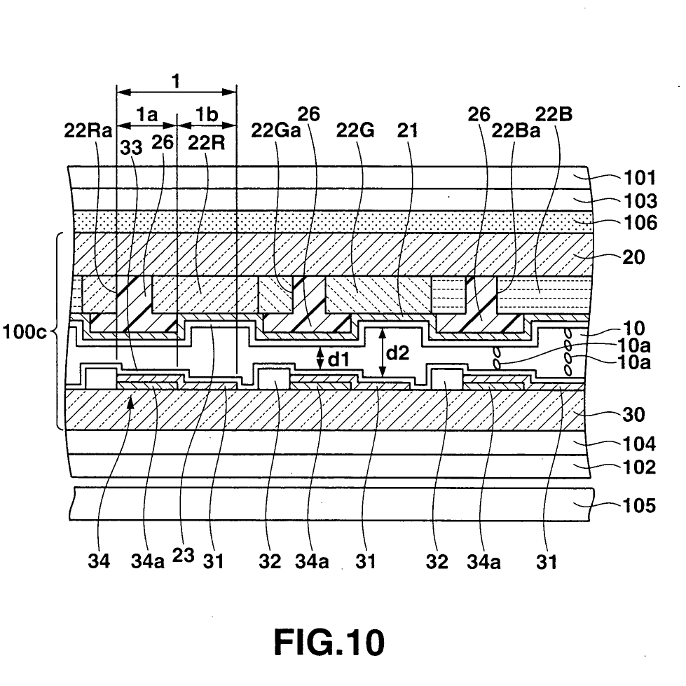

FIGS. 10 to 14B show the fourth embodiment of the present invention.

As shown in FIG. 10, the liquid crystal display device of this embodiment comprises a liquid crystal panelpanel 100c, a pair of observation- and opposite-side observation-side polarizing plates 101 and 102, two λ/4 retardation plates 103 and 104, and a diffusion layer 106. The polarizing plates 101 and 102 are arranged on both sides of the liquid crystal panel 100c. The λ/4 retardation plates 103 and 104 are respectively arranged between the polarizing plates 101 and 102 and two substrates 20 and 30 of the liquid crystal panel 100c. The diffusion layer 106 is arranged between the observation-side λ/4 retardation plate 103 and the observation-side substrate 20 of the liquid crystal panel 100c. The structure of the liquid crystal display device is the same as in the embodiment shown in FIG. 5. The same reference numerals denote the same members, and a detailed description thereof will be omitted. The structure on the opposite-side substrate 30, and color filters 22R, 22G, and 22B, counter electrode 21, and homeotropic alignment film 23 on the observation-side substrate 20, which form the liquid crystal panel 100c, are also the same as in the embodiment shown in FIG. 5. The same reference numerals denote the same members, and a detailed description thereof will be omitted.

In this liquid crystal display device, substrate gap adjusting transparent films 26 are formed, in correspondence with reflection display portions 1a of a plurality of pixels 1, on the red, green, and blue color filters 22R, 22G, and 22B arranged on the inner surface of the observation-side substrate 20 of the liquid crystal panel 100c. The substrate gap adjusting transparent films 26 make the substrate gap at the reflection display portions 1a smaller than that at transmission display portions 1b of the pixels 1.

The color filters 22R, 22G, and 22B have openings 22Ra, 22Ga, and 22Ba at parts of regions corresponding to the reflection display portions 1a of the pixels 1. The openings 22Ra, 22Ga, and 22Ba of the color filters 22R, 22G, and 22B are filled with the substrate gap adjusting transparent films 26.

Liquid crystal molecules 10a of a liquid crystal layer 10 in this liquid crystal panel are aligned almost vertically with respect to the surfaces of the pair of substrates 20 and 30. When the ON voltage is applied between electrodes 21 and 31 of the plurality of pixels 1, the liquid crystal molecules 10a are set in a lying alignment state while aligning their long axes along the rubbing directions.

In this embodiment, the substrate gap adjusting transparent films 26 are formed into such a thickness that the substrate gap at the reflection display portions 1a becomes almost ½ that at the transmission display portions 1b. Accordingly, a liquid crystal layer thickness d1 at the reflection display portions 1a becomes about ½ a liquid crystal layer thickness d2 at the transmission display portions 1b. In addition, the liquid crystal layer thicknesses d1 and d2 and a refractive index anisotropy Δn of the liquid crystal material are appropriately selected. Accordingly, a value Δnd1 of the reflection display portions 1a and a value Δnd2 of the transmission display portions 1b at the time of ON voltage application, i.e., when the liquid crystal molecules 10a are set in the lying alignment state while aligning their long axes along the rubbing directions are set to Δnd1=140±40 nm and Δnd2=270±40 nm, respectively.

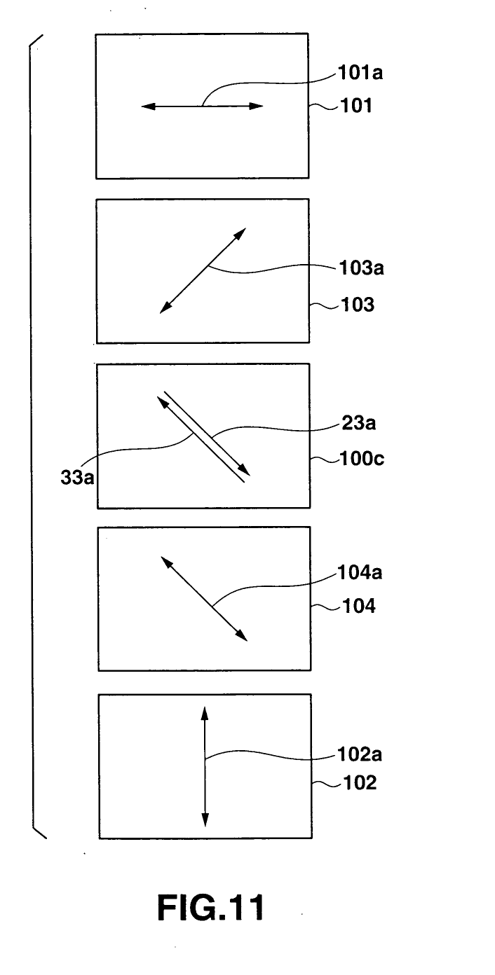

FIG. 11 shows rubbing directions 23a and 33a of the inner surfaces the pair of substrates 20 and 30 (the film surfaces of the homeotropic alignment films 23 and 33), the directions of transmission axes 101a and 102a of the observation- and opposite-side polarizing plates 101 and 102, and the directions of slow axes 103a and 104a of the observation- and opposite-side λ/4 retardation plates 103 and 104 in the liquid crystal panel 100c of this embodiment.

As shown in FIG. 11, the inner surfaces of the substrates 20 and 30 of the liquid crystal panel 100c are subjected to a rubbing process parallel to each other in reverse directions. The observation-side polarizing plate 101 is arranged while making the transmission axis 101a obliquely cross the rubbing directions 23a and 33a of the pair of substrates 20 and 30 almost at an angle of 45°. The opposite-side polarizing plate 102 is arranged while making the transmission axis 102a almost perpendicular to the transmission axis 101a of the observation-side polarizing plate 101.

The observation-side λ/4 retardation plate 103 is arranged while setting the slow axis 103a almost perpendicular or parallel to the rubbing directions 23a and 33a of the inner surfaces of the pair of substrates 20 and 30 so that the slow axis 103a obliquely crosses the transmission axis 101a of the observation-side polarizing plate 101 almost at an angle of 45°. The opposite-side λ/4 retardation plate 104 is arranged while setting the slow axis 104a almost perpendicular to the slow axis 103a of the observation-side λ/4 retardation plate 103 (almost parallel or perpendicular to the rubbing directions 23a and 33a of the inner surfaces of the pair of substrates 20 and 30) so that the slow axis 104a obliquely crosses the transmission axis 102a of the opposite-side polarizing plate 102 almost at an angle of 45°.

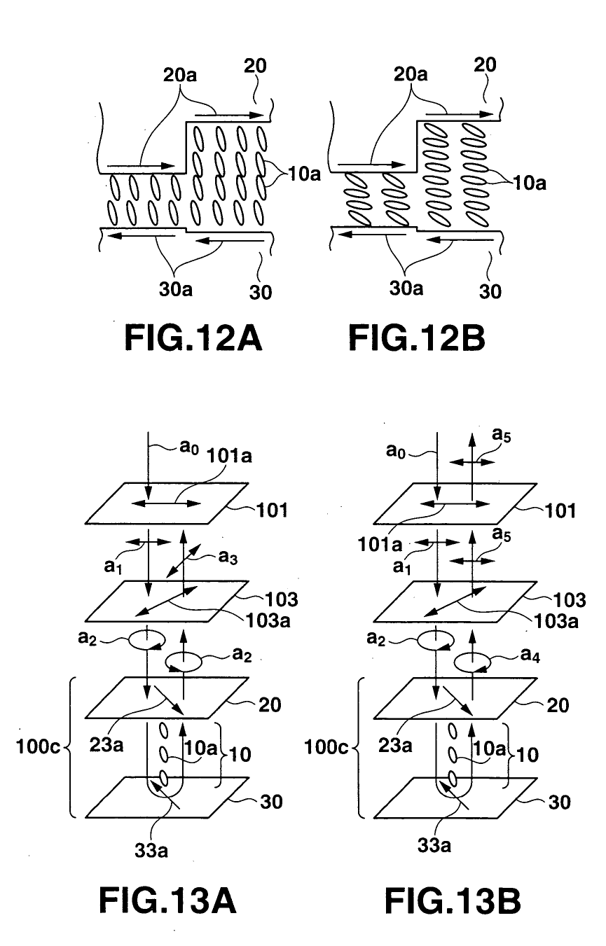

FIGS. 12A and 12B schematically show the alignment states of the liquid crystal molecules 10a of this embodiment at the times of OFF voltage application and ON voltage application. In this embodiment, the inner surfaces of the substrates 20 and 30 of the liquid crystal panel 100c are subjected to a rubbing process parallel to each other in reverse directions. Hence, when the ON voltage is applied, the liquid crystal molecules 10a in the homeotropic alignment state at the time of OFF voltage application shown in FIG. 12A are set in an untwisted homogeneous alignment state in which the liquid crystal molecules lie while aligning their long axes along the rubbing directions 23a and 33a of the surfaces of the substrates 20 and 30, as shown in FIG. 12B.

This liquid crystal display device executes display by controlling the polarized state of incident light by the birefringence effect of the liquid crystal layer 10 arranged between the pair of observation- and opposite-side substrates 20 and 30 of the liquid crystal panel 100c and the retardation of the two λ/4 retardation plates 103 and 104 arranged between the pair of substrates 20 and 30 and the observation- and opposite-side polarizing plates 101 and 102, as in the embodiment shown in FIG. 5. This liquid crystal display device has a wide view angle because the liquid crystal molecules 10a of the liquid crystal layer 10 are aligned almost vertically with respect to the surfaces of the substrates 20 and 30.

In this liquid crystal display device, when the OFF voltage is applied between the electrodes 21 and 31 of the pixels 1, the liquid crystal molecules 10a are set in the initial homeotropic alignment state. When the ON voltage is applied, almost all the liquid crystal molecules 10a between the substrates 20 and 30 change their alignment state and lie with respect to the substrate surfaces. For these reasons, the contrast is also high.

Reflection display using external light of the liquid crystal display device will be described. FIGS. 13A and 13B are schematic views showing reflection display of the liquid crystal display device. There figures show display of the reflection display portion 1a of one pixel 1 of the liquid crystal panel 100c.

FIG. 13A shows display when the OFF voltage which sets the liquid crystal molecules 10a in the initial homeotropic alignment state is applied between the electrodes 21 and 31 of the pixel 1. FIG. 13B shows display when the ON voltage which sets the liquid crystal molecules 10a in the lying alignment state is applied between the electrodes 21 and 31 of the pixel 1.

In reflection display using external light, the liquid crystal display device executes single polarizing plate display in which the polarizing plate 101 arranged on the observation side of the liquid crystal panel 100c serves as both a polarizer and an analyzer. In reflection display, external light a₀ incident from the observation side is polarized by the observation-side polarizing plate 101 into linearly polarized light a₁ parallel to the transmission axis 101a, as indicated by arrows in FIGS. 13A and 13B. The linearly polarized light a₁ is further converted by the observation-side λ/4 retardation plate 103 into circularly polarized light a₂ clockwise or counterclockwise when viewed from the traveling direction of the light and enters the liquid crystal layer 10 of the liquid crystal panel 100c.

At the time of OFF voltage application, the liquid crystal molecules 10a of the liquid crystal layer 10 are aligned almost vertically. For this reason, light which is changed by the observation-side λ/4 retardation plate 103 to the circularly polarized light a₂ and enters the liquid crystal layer 10 passes through it as the circularly polarized light a₂ almost without being affected by the birefringence effect of the liquid crystal layer 10. Of that light, a light component which enters the reflection display portions 1a of the plurality of pixels 1 and passes through the liquid crystal layer 10 is reflected by reflecting films 34a. The light component passes through the liquid crystal layer 10 again as the circularly polarized light a₂ and emerges to the observation side of the liquid crystal panel 100c, as shown in FIG. 13A.

The circularly polarized light a₂ which emerges to the observation side of the liquid crystal panel 100c is converted by the observation-side λ/4 retardation plate 103 into linearly polarized light a₃ which is almost perpendicular to the linearly polarized light a₁ which has entered from the observation side through the observation-side polarizing plate 101. Then, the linearly polarized light a₃ enters the observation-side polarizing plate 101 and is absorbed by it. Hence, the pixel 1 to which the OFF voltage is applied exhibits dark display in black.

At the time of ON voltage application, the liquid crystal molecules 10a of the liquid crystal layer 10 are set in the lying alignment state while aligning their long axes along the rubbing directions 23a and 33a of the surfaces of the substrates 20 and 30, as described above. For this reason, the light which is changed by the observation-side λ/4 retardation plate 103 to the circularly polarized light a₂ and enters the liquid crystal layer 10 changes its polarized state by the birefringence effect of the liquid crystal layer 10. Of that light, a light component which enters the reflection display portions 1a of the plurality of pixels 1 and passes through the liquid crystal layer 10 is reflected by the reflecting films 34a. The light component passes through the liquid crystal layer 10 again in a different polarized state and emerges to the observation side of the liquid crystal panel 100c.

The birefringence effect of the liquid crystal layer 10 at the reflection display portions 1a at the time of ON voltage application is almost the same as that of a λ/4 retardation plate because the value Δnd1 of the reflection display portions 1a when the liquid crystal molecules 10a are set in the lying alignment state is 140±40 nm, as described above. Hence, the light which is changed to the circularly polarized light a₂ by the observation-side λ/4 retardation plate 103 and enters the liquid crystal layer 10 at the reflection display portions 1a is converted by the liquid crystal layer 10 into linearly polarized light (not shown) which is almost the same as the linearly polarized light a₁ which has passed through the observation-side polarizing plate 101 from the observation side and entered, and is reflected by the reflecting films 34a. The light is further changed by the liquid crystal layer 10 to circularly polarized light a₄ which rotates in a direction reverse to the circularly polarized light a₂ which has passed through the observation-side λ/4 retardation plate 103 and entered the liquid crystal layer 10. The light then emerges to the observation side of the liquid crystal panel 100c, as shown in FIG. 13B.

The circularly polarized light a₄ which emerges to the observation side of the liquid crystal panel 100c is converted by the observation-side λ/4 retardation plate 103 into linearly polarized light as which is almost the same as the linearly polarized light a₁ which has passed through the polarizing plate 101 from the observation side and entered, and enters the polarizing plate 101. The linearly polarized light as passes through the observation-side polarizing plate 101 and emerges to the observation side. The pixel 1 to which the ON voltage is applied exhibits bright display in one of red, green, and blue colored by the color filters 22R, 22G, and 22B.

In reflection display, of the light which has entered from the observation side, a light component which enters the transmission display portions 1b of the plurality of pixels 1 and passes through the liquid crystal layer 10 emerges to the opposite side of the liquid crystal panel 100c.

That is, the liquid crystal display device executes reflection display in a normally black mode in which display at the time of OFF voltage application is black display. When the OFF voltage is applied to set the liquid crystal molecules 10a in the initial homeotropic alignment state, darkest display in black is obtained. When the ON voltage is applied to set the liquid crystal molecules 10a in the lying alignment state, brightest display (display in red, green, or blue colored by the color filters 22R, 22G, and 22B) is obtained.

The liquid crystal display device has, on the second substrate 30 on the opposite side of the observation side of the liquid crystal panel 100c, the reflection means 34 for dividing each of the plurality of pixels 1 into the reflection display portion 1a and the transmission display portion 1b. For this reason, a color image by reflection display can sufficiently be bright.

In this liquid crystal display device, the color filters 22R, 22G, and 22B respectively have the openings 22Ra, 22Ga, and 22Ba at parts of regions corresponding to the reflection display portions 1a of the pixels 1. In reflection display, colored light components in red, green, and blue colored by the color filters 22R, 22G, and 22B and noncolored light components that have passed through the openings 22Ra, 22Ga, and 22Ba are observed from the reflection display portions 1a of the plurality of pixels 1. Hence, a bright color image can be displayed.

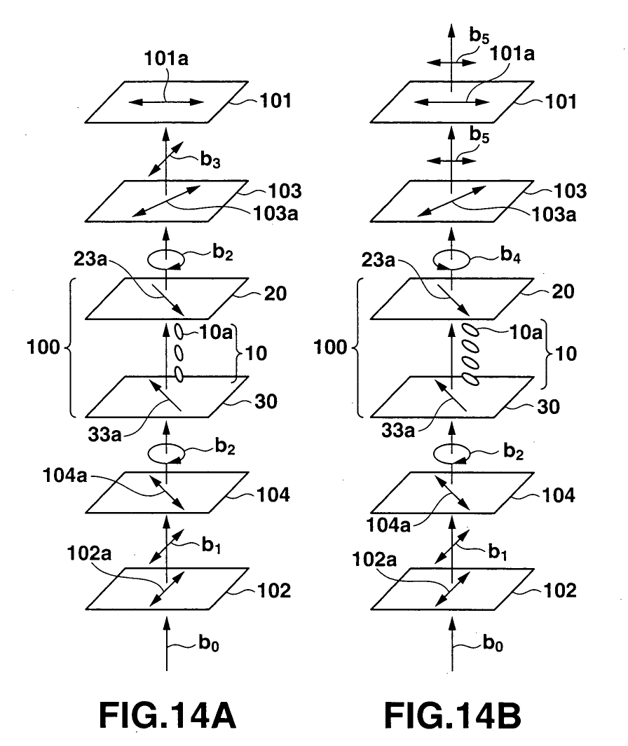

Transmission display using illumination light from the surface light source 105 will be described next. FIGS. 14A and 14B are schematic views showing transmission display of the liquid crystal display device. FIGS. 14A and 14B show display of the transmission display portion 1b of one pixel 1 of the liquid crystal panel 100c.

FIG. 14A shows display when the OFF voltage which sets the liquid crystal molecules 10a in the initial homeotropic alignment state is applied between the electrodes 21 and 31 of the pixel 1. FIG. 14B shows display when the ON voltage which sets the liquid crystal molecules 10a in the lying alignment state is applied between the electrodes 21 and 31 of the pixel 1.

In transmission display using illumination light from the surface light source 105, the liquid crystal display device executes display by using the second polarizing plate 102 arranged on the opposite side of the liquid crystal panel 100c as a polarizer and the first polarizing plate 101 arranged on the observation side of the liquid crystal panel 100c as an analyzer. In transmission display, illumination light b₀ incident from the opposite side of the observation side is polarized by the opposite-side polarizing plate 102 into linearly polarized light b₁ parallel to the transmission axis 101a, as indicated by arrows in FIGS. 14A and 14B. The linearly polarized light b₁ is further converted by the opposite-side λ/4 retardation plate 104 into circularly polarized light b₂ clockwise or counterclockwise when viewed from the traveling direction of the light and enters the transmission display portions 1b of the pixels 1. The light enters the liquid crystal layer 10 of the liquid crystal panel 100c.

At the time of OFF voltage application, the liquid crystal molecules 10a of the liquid crystal layer 10 are aligned almost vertically. For this reason, light which is changed by the opposite-side λ/4 retardation plate 104 to the circularly polarized light b₂ and enters transmission display portion 1b of the pixel 1 passes through the liquid crystal layer 10 as the circularly polarized light b₂ almost without being affected by the birefringence effect of the liquid crystal layer 10. The light emerges to the observation side of the liquid crystal panel 100c, as shown in FIG. 14A.

The circularly polarized light b₂ which emerges to the observation side of the liquid crystal panel 100c is converted by the observation-side λ/4 retardation plate 103 into linearly polarized light having an oscillation surface that almost matches the absorption axis of the observation-side polarizing plate 101, i.e., linearly polarized light b₃ which is almost the same as the linearly polarized light b₁ which has passed through the opposite-side polarizing plate 102 and entered. The linearly polarized light b₃ enters the observation-side polarizing plate 101 and is absorbed by it. Hence, the pixel 1 to which the OFF voltage is applied exhibits dark display in black.

At the time of ON voltage application, the liquid crystal molecules 10a of the liquid crystal layer 10 are set in the lying alignment state while aligning their long axes along the rubbing directions 23a and 33a of the inner surfaces of the substrates 20 and 30, as described above. For this reason, the light which is changed by the opposite-side λ/4 retardation plate 104 to the circularly polarized light b₂ and enters the transmission display portion 1b of the pixel 1 changes its polarized state by the birefringence effect of the liquid crystal layer 10. Then, the circularly polarized light b₂ emerges to the observation side of the liquid crystal panel 100c.

The birefringence effect of the liquid crystal layer 10 at the reflection display portions 1a upon the time of ON voltage application is almost the same as that of a λ/2 retardation plate, because the value Δnd2 of the transmission display portion 1b when the liquid crystal molecules 10a are set in the lying alignment state is 270±40 nm, as described above. Hence, the light which is changed to the circularly polarized light b₂ by the opposite-side λ/4 retardation plate 104 and enters the liquid crystal layer 10 at the transmission display portions 1b is converted by the liquid crystal layer 10 into circularly polarized light b₄ which rotates in a reverse direction and emerges to the observation side of the liquid crystal panel 100c, as shown in FIG. 14B.

The circularly polarized light b₄ which emerges to the observation side of the liquid crystal panel 100c is converted by the observation-side λ/4 retardation plate 103 into linearly polarized light having an oscillation plane that almost matches the transmission axis 101a of the observation-side polarizing plate 101, i.e., linearly polarized light b₅ which is almost perpendicular to the linearly polarized light b₁ which has passed through the opposite-side polarizing plate 102 and entered. The linearly polarized light b₅ enters the observation-side polarizing plate 101, passes through it, and then emerges to the observation side. Accordingly bright display in one of red, green, and blue colored by the color filters 22R, 22G, and 22B is obtained.

That is, the liquid crystal display device executes display in the normally black mode even in transmission display using illumination light from the surface light source 105. When the OFF voltage is applied to set the liquid crystal molecules 10a in the initial homeotropic alignment state, darkest display in black is obtained. When the ON voltage is applied to set the liquid crystal molecules 10a in the lying alignment state, brightest display (display in colored red, green, or blue) is obtained.

According to this liquid crystal display device, display at a wide view angle and high contrast can be obtained. In addition, both color image display by reflection display using external light and color image display by transmission display using illumination light from the surface light source 105 arranged on the opposite side of the observation side can be executed. Color images in both modes can sufficiently be bright.

The surface light source 105 can also be used as an auxiliary light source in reflection display using external light. Even in this case, since both reflection display and transmission display are in the normally black mode, high-contrast display can be obtained.

In this liquid crystal display device, the liquid crystal layer thickness d1 at the reflection display portions 1a of the pixel 1 is smaller than the liquid crystal layer thickness d2 at the transmission display portion 1b. For this reason, the difference between the birefringence effect of the liquid crystal layer 10 for light which reciprocally passes through the liquid crystal layer 10 at the reflection display portion 1a and the birefringence effect of the liquid crystal layer 10 for light which passes through the liquid crystal layer 10 at the transmission display portion 1b only once can be small. For this reason, a color image by reflection display and that by transmission display can be displayed almost without any difference in quality.

In this embodiment, the liquid crystal layer thickness d1 at the reflection display portion 1a is almost ½ the liquid crystal layer thickness d2 at the transmission display portion 1b. The value Δnd1 of the reflection display portion 1a and the value Δnd2 of the transmission display portion 1b at the time of ON voltage application (when the liquid crystal molecules 10a are set in the lying alignment state while aligning their long axes along the rubbing directions) are set to Δnd1=140±40 nm and Δnd2=270±40 nm, respectively. Hence, as described above, in both reflection display and transmission display, darkest display in black can be obtained by applying the OFF voltage, and brightest display can be obtained by applying the ON voltage.

In this embodiment, the transparent films 26 are formed on the inner surface of one of the substrates 20 and 30 and, for example, the observation-side substrate 20 of the liquid crystal panel 100c in correspondence with reflection display portions 1a of the plurality of pixels 1. The transparent films 26 make the substrate gap at the reflection display portions 1a smaller than that at the transmission display portions 1b of the pixels 1. With the simple structure, the liquid crystal layer thickness d1 at the reflection display portions 1a of the plurality of pixels 1 can be made smaller than the liquid crystal layer thickness d2 at the transmission display portions 1b.

In the above-described embodiment, the inner surfaces of the pair of substrates 20 and 30 (the film surfaces of the homeotropic alignment films 23 and 33) of the liquid crystal panel 100c may be subjected to a rubbing process parallel to each other in the same direction. Even in this case, the lying direction of the liquid crystal molecules 10a when the ON voltage is applied can be defined along the rubbing direction, and a higher contrast can be obtained, as in the above-described embodiment.

The rubbing process may be executed either for the inner surface of only one of the pair of substrates 20 and 30 or for none of the pair of substrates 20 and 30.

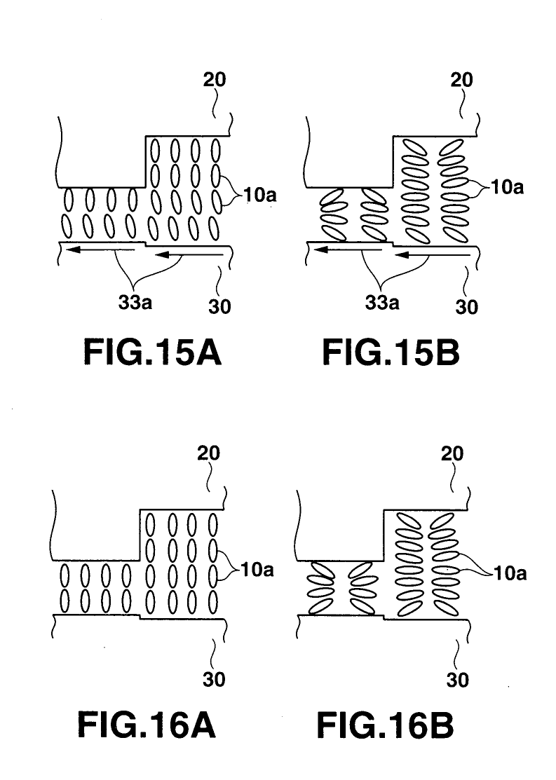

FIGS. 15A and 15B are schematic views showing the alignment states of the liquid crystal molecules 10a at the times of OFF voltage application and ON voltage application when the rubbing process is executed for the inner surface of only one of the pair of substrates 20 and 30 and, for example, the inner surface of the opposite-side substrate 30. When the rubbing process is executed for only the inner surface of the second substrate 30, and the ON voltage is applied, the liquid crystal molecules 10a in the homeotropic alignment state at the time of OFF voltage application shown in FIG. 15A lie almost horizontally while aligning their long axes along the rubbing direction 33a of the opposite-side substrate 30, as shown in FIG. 15B. In this case, there exist alignment states with opposite tilting directions with respect to the inner surface of the first substrate 20 which has not undergone the rubbing process. Hence, the view angle of display can be made wider.

FIGS. 16A and 16B are schematic views showing the alignment states of the liquid crystal molecules 10a at the times of OFF voltage application and ON voltage application when the rubbing process is executed for none of the pair of substrates 20 and 30. When the rubbing process is executed for both substrates 20 and 30, and the ON voltage is applied, the liquid crystal molecules 10a in the homeotropic alignment state at the time of OFF voltage application shown in FIG. 16A are set in two alignment states with opposite tilting directions with respect to the inner surfaces of both of substrates 20 and 30, as shown in FIG. 16B. Hence, the view angle of display can be made wider.

[Fifth Embodiment]

In the above embodiment, a three-dimensional pattern may be formed on the reflecting surfaces 34a of the reflection means 34 for dividing each of the plurality of pixels 1 of the liquid crystal panel 100c into the reflection display portion 1a and the transmission display portion 1b, and the diffusion layer 106 may be omitted.

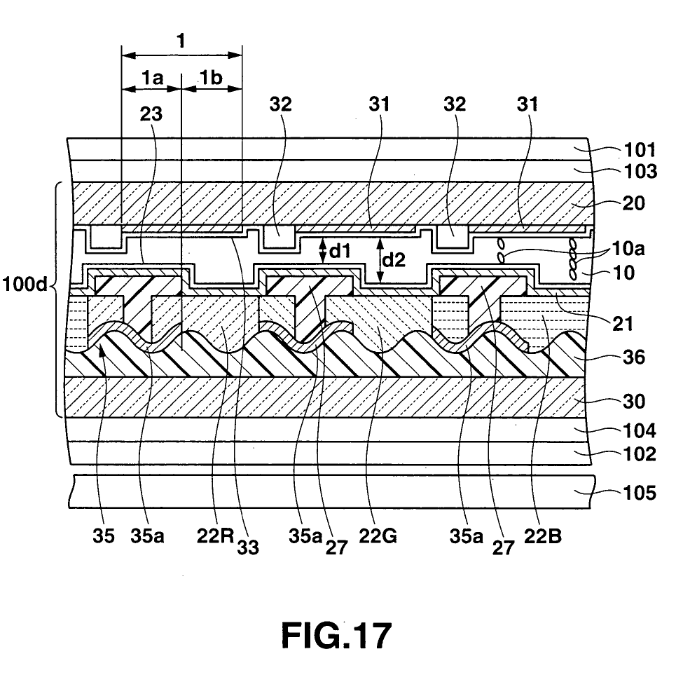

FIG. 17 is a sectional view of part of a liquid crystal display device according to the fifth embodiment of the present invention. The liquid crystal display device comprises a liquid crystal panelpanel 100d in which a reflection means 35 is formed by a plurality of reflecting films 35a having a three-dimensional pattern on their reflecting surfaces.

In this embodiment, the liquid crystal assembly 100d is an active matrix liquid crystal panel. The liquid crystal panel 100d has, on the inner surface of an observation-side substrate 20, a plurality of pixel electrodes 31, TFTs 32, gate wiring lines (not shown), and data wiring lines (not shown). The liquid crystal panel 100d also has, on the inner surface of an opposite-side substrate 30, reflection means 35, color filters 22R, 22G, and 22B of three colors, i.e., red, green, and blue, a substrate gap adjusting transparent film 27, and a counter electrode 21. Reflecting films 35a which form the reflection means 35 adhere to a transparent three-dimensional surface film 36 arranged on the inner surface of the second substrate 30. The entire surface of the three-dimensional surface film 36 is formed into a three-dimensional pattern.

In the liquid crystal display device of this embodiment, a liquid crystal layer 10 of the liquid crystal panel 10d, a value Δnd1 of reflection display portions 1a of a plurality of pixels 1, and a value Δnd2 of transmission display portions 1b are the same as in the fourth embodiment. The arrangement states of polarizing plates 101 and 102 and λ/4 retardation plates 103 and 104 are also the same as in the fourth embodiment, and a repetitive description thereof will be omitted.

In the liquid crystal display device of this embodiment, the reflection means 35 for dividing each of the plurality of pixels 1 of the liquid crystal panel 100d into the reflection display portion 1a and transmission display portion 1b is formed by the plurality of reflecting films 35a. The reflecting films 35a have three-dimensional patterns on their reflecting surfaces and are arranged in correspondence with the reflection display portions 1a for the plurality of pixels 1. For this reason, reflection display using external light can be brighter, and the view angle can be wider.

In this embodiment, the three-dimensional surface film 36 having a three-dimensional pattern on the entire surface is arranged on the surface of the opposite-side substrate 30 of the liquid crystal panel 100d. The reflecting films 35a are formed on the three-dimensional surface film 36. For this reason, even in transmission display using illumination light from a surface light source 105, diffused light can emerge from the three-dimensional surface film 36 so that the view angle can be wider.

The three-dimensional pattern may be formed on the reflecting surfaces of the reflecting films 35a by another means. In addition, undiffused light may emerge in transmission display.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A liquid crystal display device comprising:
a homeotropic alignment liquid crystal panel including
observation-side and opposite-side substrates which oppose each other,
a plurality of electrodes which are arranged on sides of opposing inner surfaces of the substrates and form a plurality of pixels by opposing regions, and
a liquid crystal layer which is arranged between the substrates and made of a liquid crystal material with negative dielectric anisotropy in which liquid crystal molecules are aligned substantially vertically with respect to the inner surfaces of the substrates;
a pair of polarizing plates which are respectively arranged on both sides of the homeotropic alignment liquid crystal panel; and
a pair of λ/4 retardation plates which are respectively arranged between the homeotropic alignment liquid crystal panel and the pair of polarizing plates.

2. A device according to claim 1, wherein the homeotropic alignment liquid crystal panel includes homeotropic alignment films which are formed on the inner surfaces of the substrates on which the plurality of electrodes are formed, and
in which a rubbing process is executed for at least one of the homeotropic alignment films on the substrates in a predetermined direction.

3. A device according to claim 2, wherein the homeotropic alignment films formed on the inner surfaces of the substrates are subjected to the rubbing process parallel to each other.

4. A device according to claim 1, wherein the paired λ/4 retardation plates are arranged while setting slow axes perpendicular to each other.

5. A device according to claim 4, wherein one of the paired λ/4 retardation plates is arranged while making the slow axis cross an optical axis of one of the pair of polarizing plates substantially at 45°.

6. A device according to claim 5, wherein one of the paired λ/4 retardation plates is arranged while setting the slow axis perpendicular to a rubbing direction of the homeotropic alignment film.

7. A device according to claim 1, wherein the homeotropic alignment liquid crystal panel includes reflection sections which are arranged on the inner surface of the opposite-side substrate, each of the reflection sections dividing each of the plurality of pixels into a reflection display portion which reflects incident light from an observation side to the observation side and a transmission display portion which makes incident light from the opposite-side substrate pass to the observation side.

8. A device according to claim 1, wherein the homeotropic alignment liquid crystal panel further includes a gap adjusting film to adjust a thickness of the liquid crystal layer.

9. A liquid crystal display device comprising:
a homeotropic alignment liquid crystal panel including
observation-side and opposite-side substrates which oppose each other,
electrodes which are arranged on each of opposing inner surfaces of the pair of substrates and form a plurality of pixels by opposing regions,
color filters of three colors of red, green, and blue which are arranged on the inner surface of one of the substrates in correspondence with the plurality of pixels,
reflection sections arranged on the opposite-side substrate, each of the reflection sections dividing each of the plurality of pixels into a reflection display portion which reflects incident light from an observation side to the observation side and a transmission display portion which makes incident light from the opposite-side substrate pass to the observation side, and
a liquid crystal layer which is sealed between the substrates and made of a liquid crystal material with negative dielectric anisotropy in which liquid crystal molecules are aligned substantially vertically with respect to the inner surfaces of the substrates;
observation-side and opposite-side polarizing plates which are respectively arranged on both sides of the homeotropic alignment liquid crystal panel; and
a λ/4 retardation plate which is arranged at least between the observation-side substrate and the observation-side polarizing plate.

10. A device according to claim 9, wherein the reflection sections have a plurality of reflecting films which are arranged in correspondence with the reflection display portions of the plurality of pixels.

11. A device according to claim 10, wherein each of the reflecting films has a reflecting surface which has a three-dimensional pattern.

12. A device according to claim 9, wherein a transparent opening portion is formed for the reflection display portion of each of the color filters of three colors arranged in correspondence with the plurality of pixels.

13. A device according to claim 11, wherein a transparent member is formed in the transparent opening portion which is formed for the reflection display portion of each of the color filters.

14. A device according to claim 13, wherein the transparent member includes a gap adjusting film which covers the color filters to adjust a thickness of the liquid crystal layer.

15. A liquid crystal display device comprising:
a homeotropic alignment liquid crystal panel including
observation-side and opposite-side substrates which oppose each other,
electrodes which are arranged on each of opposing inner surfaces of the substrates and form a plurality of pixels by opposing regions,
color filters of three colors, i.e., red, green, and blue which are arranged on the inner surface of one of the substrates in correspondence with the plurality of pixels,
reflection sections arranged on an opposite-side substrate which opposes the observation-side substrate, for dividing each of the plurality of pixels into a reflection display portion which reflects incident light from an observation side to the observation side and a transmission display portion which makes incident light from the opposite-side substrate pass to the observation side,
a transparent member which is arranged in correspondence with reflection display portion of each of the pixels of the color filters to adjust a thickness of a liquid crystal layer, and
a liquid crystal layer which is arranged between the substrates and made of a liquid crystal material with negative dielectric anisotropy in which liquid crystal molecules are aligned substantially vertically with respect to the inner surfaces of the substrates, and a thickness of the reflection display portions of the plurality of pixels is smaller than that of the transmission display portions;
a pair of polarizing plates which are arranged on both sides of the homeotropic alignment liquid crystal panel; and
two λ/4 retardation plates which are respectively arranged between the homeotropic alignment liquid crystal panel and the pair of polarizing plates.

16. A device according to claim 15, wherein each of the color filters has, at a position corresponding to the reflection display portion, an opening portion to reflect a light component of light incident on the reflection display portion without coloring the light component.

17. A device according to claim 15, wherein the transparent member fills the opening portion of the color filter and is made of a transparent material which is arranged in a region corresponding to the reflection display portion to reduce the thickness of the liquid crystal layer at the reflection display portion.

18. A device according to claim 15, wherein each of the plurality of electrodes has a transparent electrode formed from a transparent conductive material, and the reflection sections are formed on a substrate side of the transparent electrode on the opposite-side substrate.

19. A device according to claim 15, wherein the homeotropic alignment films formed on the inner surfaces of the substrates are subjected to the rubbing process parallel to each other.

20. A device according to claim 15, wherein the two λ/4 retardation plates are arranged while setting slow axes perpendicular to each other, and one of the two λ/4 retardation plates is arranged while making the slow axis cross an optical axis of one of the pair of polarizing plates substantially at 45°.
